(19) United States
(12) Patent Application Publication
(10) Pub. No.: US 2006/0147735 A1
(43) Pub. Date: Jul. 6, 2006

(54) Chemical conversion treating agent and surface treated metal

(75) Inventors: Masahiko Matsukawa, Tokyo (JP); Kazuhiro Makino, Tokyo (JP); Toshiaki Shimakura, Tokyo (JP); Hiroshi Hosono, Toyota-shi (JP)

Correspondence Address: CONNOLLY BOVE LODGE & HUTZ LLP, SUITE 800, 1990 M STREET NW, WASHINGTON, DC, 20036-3425, US

(73) Assignees: Nippon Paint Co., Ltd., Osaka-shi (JP); Toyota Jidosha Kabuhikia Kaisha, Aichi (JP)

(21) Appl. No.: 11/295,477

(22) Filed: Dec. 7, 2005

(30) Foreign Application Priority Data
Dec. 8, 2004 (JP) 2004-355863

(51) Int. Cl. B32B 15/04; C08K 3/22

(52) U.S. Cl. 428/469; 428/472; 524/413

(57) ABSTRACT

It is an object of the invention to provide a chemical conversion treating agent which contains no chromium and can give good effect of chemical conversion treatment equal to or better than that of zinc phosphate treatment to all metals such as iron, zinc, aluminum and the like. The present invention provides a chemical conversion treating agent comprising zirconium, fluorine and a water-soluble epoxy compound, wherein the content of the zirconium in the chemical conversion treating agent is 20 to 10000 ppm on the metal equivalent basis, the water-soluble epoxy compound has a fundamental skeleton of bisphenol F, has an amino group and an isocyanate group, has a number-average molecular weight of 400 to 1000, and the content of the water-soluble epoxy compound in the chemical conversion treating agent is 100 to 2000 ppm in terms of the concentration of solid matters.

### TECHNICAL FIELD

The present invention relates to a chemical conversion treating agent and a surface treated metal.

### BACKGROUND ART

When the surface of a metal substrate is subjected to cationic electrodeposition, chemical conversion treatment is generally applied for the purpose of improving properties such as corrosion resistance, adhesion of a film, and the like. Since it has been pointed out that chromate treatment, which has been employed in the chemical conversion treatment from the viewpoint of being able to improve the adhesion and corrosion resistance of a film much more, has a deleterious property of chromium in recent years, the development of a chemical conversion treating agent containing no chromium has been required. As such a chemical conversion treating agent, there is known a metal surface treating agent comprising a zirconium compound (see, for example, Japanese Kokai Publication Hei-07-310189).

However, a chemical conversion coat obtained from a metal surface treating solution comprising a zirconium compound has low adhesion to a film obtained by cationic electrodeposition or powder coating and the treating solution is generally less used in a pretreatment process of such a coating.

In addition, since the coat obtained from the metal surface treating solution comprising a zirconium compound had inadequate adhesion particularly to an iron-based substrate, it was difficult to form a good chemical conversion coat on the iron-based substrate. Thus, the metal surface treatment solution cannot treat the surfaces comprising various metal materials such as iron, zinc, aluminum and the like, by one operation, and treatment with such a solution is inefficient from the viewpoint of the workability. Therefore, there is desired the development of a chemical conversion treating agent which contains no chromium and can apply chemical conversion treatment to a surface comprising various metal materials by one operation.

### SUMMARY OF THE INVENTION

In view of the above-mentioned state of the art, it is an object of the invention to provide a chemical conversion treating agent which contains no chromium and can give good effects of chemical conversion treatment equal to or better than that of zinc phosphate treatment to all metals such as iron, zinc, aluminum and the like.

The present invention provides a chemical conversion treating agent comprising zirconium, fluorine and a water-soluble epoxy compound,

wherein the content of the zirconium in the chemical conversion treating agent is 20 to 10000 ppm on the metal equivalent basis,

the water-soluble epoxy compound has a fundamental skeleton of bisphenol F, has an amino group and an isocyanate group, has a number-average molecular weight of 400 to 1000, and the content of the water-soluble epoxy compound in the chemical conversion treating agent is 100 to 2000 ppm in terms of the concentration of solid matters.

Preferably, the chemical conversion treating agent further comprises,
at least one member selected from the group consisting of at least one metal ion selected from the group consisting of a zinc ion, a magnesium ion, a calcium ion, an aluminum ion and an iron ion (A); a copper ion (B); and silicon-containing compound (C).

Preferably, the silicon-containing compound (C) is at least one member selected from the group consisting of silica, a water-soluble silicate compound, silicate esters, alkyl silicates and a silane coupling agent.

Preferably, the chemical conversion treating agent has a pH of 1.5 to 6.5.

The present invention also provides a surface treated metal having a chemical conversion coat obtainable from the above-mentioned chemical conversion treating.

Preferably, an amount of the chemical conversion coat is 0.1 to 500 mg/m² in terms of the total amount of all metals supplied from the chemical conversion treating agent and carbons in the epoxy compound.

Preferably, an article to be treated of the surface treated metal is an automobile body.

### DETAILED DESCRIPTION OF THE INVENTION

Hereinafter, the present invention will be described in detail.

The present invention pertains to a chemical conversion treating agent containing zirconium and fluorine, and not containing harmful heavy metal ions such as chromium and the like. When a metal substrate is treated with a common zirconium-containing chemical conversion treating agent, it is considered that a metal ion which has been eluted in the chemical conversion treating agent catches a fluorine ion of ZrF₆²⁻, and a hydroxide or an oxide of zirconium is produced by an increase in a pH at an interface and this hydroxide or oxide of zirconium is precipitated on the surface of the substrate.

When such a chemical conversion treating agent contains an epoxy compound, the epoxy compound chelates zirconium. It is estimated that adhesion between a zirconium coat and an epoxy compound coat is strongly progressed by this chelate formation. It is estimated that since the above-mentioned epoxy compound coat comprises organic components, it has a strong affinity for resin components in a film further formed on the epoxy compound coat by electrodeposition or powder coating and thereby intense adhesion is attained.

Further, since the chemical conversion treating agent of the present invention contains an ingredient acting as a curing agent, a crosslinking reaction is started on the above-mentioned epoxy compound coat and thereby an organic coat layer having the excellent physical properties and the excellent adhesion and corrosion resistance can be formed.

Zirconium contained in the above-mentioned chemical conversion treating agent is a component forming a chemical conversion coat, and by forming a chemical conversion coat containing zirconium on a substrate, the corrosion resistance and the wear resistance of the substrate can be improved and further the adhesion to a film to be formed next can be enhanced.

A supply source of the above-mentioned zirconium is not particularly limited, and examples thereof include alkali metal fluorozirconates such as K₂ZrF₆ and the like; fluorozirconates such as (NH₄)₂ZrF₆ and the like; soluble fluorozirconates like fluorozirconic acid such as H₂ZrF₆ and the like; zirconium fluoride; zirconium oxide and the like.

The content of the zirconium contained in the above-mentioned chemical conversion treating agent preferably ranges from 20 ppm of a lower limit to 10000 ppm of an upper limit on the metal equivalent basis. When this content is less than the lower limit, performance of the chemical conversion coat to be obtained is inadequate, and when it exceeds the upper limit, anymore effect cannot be expected and it is economically disadvantageous. The lower limit is more preferably 50 ppm and the upper limit is more preferably 2000 ppm.

Fluorine contained in the chemical conversion treating agent acts as an etchant of the substrate. A supply source of the fluorine is not particularly limited, and examples thereof include fluorides such as hydrofluoric acid, ammonium fluoride, fluoboric acid, ammonium hydrogen fluoride, sodium fluoride, sodium hydrogen fluoride and the like. In addition, an example of a complex fluoride includes hexafluorosilicates. Specific examples of hexafluorosilicates include fluorosilic acid, zinc hydrosilicofluoride, manganese hydrosilicofluoride, magnesium hydrosilicofluoride, nickel hydrosilicofluoride, iron hydrosilicofluoride, calcium hydrosilicofluoride and the like.

The chemical conversion treating agent of the present invention contains a water-soluble epoxy compound. When the water-soluble epoxy compound is mixed in a chemical conversion treating agent, it is considered that since the affinity for a coating composition resin is improved by an epoxy skeleton, the adhesion of a film is enhanced and good stability of the film can be exhibited.

The water-soluble epoxy compound used in the present invention is not particularly limited as long as it has a skeleton of bisphenol F and the solubility of such a level that the compound in a required amount can be dissolved in the chemical conversion treating agent, and examples thereof include a bisphenol F-type epoxy resin and the like. The bisphenol F-type epoxy resin is not particularly limited, and examples thereof include a bisphenol F propylene oxide addition-type epoxy resin, a bisphenol F epichlorohydrin-type epoxy resin and the like. The water-soluble epoxy compound having a fundamental skeleton of bisphenol F can provide excellent corrosion resistance of substrates and therefore it is preferred.

The above-mentioned water-soluble epoxy compound further has an amino group and an isocyanate group. The water-soluble epoxy compound is a cationic compound because of having an amino group and may adjust balance between a hydrophilic property and a hydrophobic property, and therefore, the compound has properties of which it is to be insoluble and precipitated by increasing pH of an aqueous solution. Thus, the above-mentioned epoxy compound is precipitated on the metal surface easily by increasing pH at the interface of the metal and the aqueous solution. As a result of analyzing by X-ray photoelectron spectroscopy, it became obvious that the water-soluble epoxy compound having an amino group was precipitated on a chemical conversion coat comprising zirconium. It is estimated that since the obtained chemical conversion coat has such a structure, the adhesion can be improved. The above-mentioned amino group is not particularly limited, and examples thereof include a —NH₂ group, a monoalkylamino group, a dialkylamino group, a monohydroxyamino group, a dihydroxyamino group, compounds having a primary, a secondary or a tertiary amine, and the like.

A reaction by which an amino group is introduced into an epoxy resin forming the above-mentioned skeleton is not particularly limited and a common method such as a method of mixing an epoxy resin and an amine compound in a solvent can be given.

The water-soluble epoxy compound having an isocyanate group can provide a curing property to a coat to be obtained. The reason for this is that a crosslinking reaction with the water-soluble epoxy compound is initiated by the isocyanate group. That is, by having an isocyanate group, a curing reaction occurs after the formation of a coats and which can form an organic coat layer which improve physical properties of a film to provide excellent adhesion and corrosion resistance.

The above-mentioned isocyanate group can be introduced into the water-soluble epoxy compound, for example, by reacting a half-blocked diisocyanate compound blocked with a blocking agent with a water-soluble epoxy compound.

The above-mentioned half-blocked diisocyanate compound can be obtained by reacting a diisocyanate compound with a blocking agent in such the proportion that an amount of an isocyanate group is excessive. As a blocking agent which can be used in the reaction, the compounds described above can be used. Synthesis of the above-mentioned half-blocked diisocyanate compound and a reaction of the half-blocked diisocyanate compound and the water-soluble epoxy compound are not particularly limited, and they can be performed by a publicly known method.

The half-blocked diisocyanate compound is obtained by adding a blocking agent to the diisocyanate compound, and the blocking agent is dissociated to produce an isocyanate group by heating. The diisocyanate compound is not particularly limited, and examples thereof include aliphatic diisocyanates such as hexamethylene diisocyanate (including trimers), tetramethylene diisocyanate, trimethylhexamethylene diisocyanate and the like; alicyclic diisocyanates such as isophorone diisocyanate and the like; aromatic diisocyanates such as 4,4′-diphenylmethane diisocyanate, trilene diisocyanate, xylylene diisocyanate and the like, etc.

The above-mentioned blocking agent is not particularly limited, and examples thereof include monohydric alkyl (or aromatic) alcohols such as n-butanol, n-hexyl alcohol, 2-ethylhexanol, lauryl alcohol, phenol carbinol, methyl phenyl carbinol and the like; cellosolves such as ethylene glycol monohexyl ether, ethylene glycol mono2-ethylhexyl ether and the like; phenols such as phenol, p-tert-butylphenol, cresol and the like; oximes such as dimethylketoxime, methyl ethyl ketoxime, methyl isobutyl ketoxime, methyl amyl ketoxime, cyclohexanone ketoxime and the like; lactams typified by ε-caprolactam and γ-butyrolactam, and the like. Since the blocking agents of oximes and lactams are dissociated at low temperatures, they are more preferred from the viewpoint of resin curability.

The water-soluble epoxy compound may have a phosphorus element. The phosphorus element is preferably contained in the water-soluble epoxy compound as a phosphate ester group. The phosphate ester group may be partially alkylated. The phosphate ester group can be introduced in the epoxy compound by the reaction of the epoxy group with the phosphate compound.

The water-soluble epoxy compound has a number-average molecular weight within a range from 400 of a lower limit to 1000 of an upper limit. When the number-average molecular-weight is less than 400, it may be impossible to maintain the good adhesion and the stability of a film. When the number-average molecular weight exceeds 1000, it is not preferred because the stability of a solution is deteriorated. Incidentally, herein, the number-average molecular weight is a value obtained by measuring according to a GPC method (on the polyethylene equivalent basis).

The chemical conversion treating agent of the present invention comprises the above-mentioned water-soluble epoxy compound in the concentration of solid matters within a range from 100 ppm of a lower limit to 2000 ppm of an upper limit. When the content is less than 100 ppm, it may be impossible to attain proper post-coating performance of a chemical conversion coat to be obtained, and when the content exceeds 2000 ppm, the stability of the chemical conversion treating agent may be deteriorated. A preferable lower limit is 200 ppm and a preferable upper limit is 600 ppm.

The chemical conversion treating agent of the present invention preferably further comprises at least one member selected from the group consisting of at least one metal ion selected from the group consisting of a zinc ion, a magnesium ion, a calcium ion, an aluminum ion and an iron ion (A); a copper ion (B); and silicon-containing compound (C). By containing these components, the treating agent can improve the adhesion of a film.

The content of the at least one metal ion selected from the group consisting of a zinc ion, a magnesium ion, a calcium ion, an aluminum ion and an iron ion (A) is preferably within a range from 1 ppm of a lower limit to 5000 ppm of an upper limit. When the content is less than 1 ppm, the corrosion resistance of a chemical conversion coat to be obtained is deteriorated and it is not preferred. When the content exceeds 5000 ppm, any more improvement in an effect is not recognized and it is economically disadvantageous and the adhesion after coating may be deteriorated. The lower limit is more preferably 20 ppm and the upper limit is more preferably 2000 ppm.

The content of the copper ion (B) is preferably within a range from 0.5 ppm of a lower limit to 100 ppm of an upper limit. When the content is less than 0.5 ppm, the corrosion resistance of a chemical conversion coat to be obtained is deteriorated and it is not preferred. When it exceeds 100 ppm, this may acts negatively on a zinc-based substrate and an aluminum-based substrate. The lower limit is more preferably 2 ppm and the upper limit is more preferably 50 ppm. Since the copper ion particularly has a high effect of stabilizing the chemical conversion coat by displacement plating of the surface of the metal substrate and stabilizes the rust produced on the surface of the metal substrate, the copper ion is estimated to be able to attain a higher effect than another components in a small amount.

Supply sources of the above-mentioned components (A) and (B) are not particularly limited and they can be mixed in the chemical conversion treating agent as, for example, nitrified substances, sulfated substances or fluorides. In particular, nitrified substances are preferred because it does not have an adverse effect on a chemical conversion reaction.

The silicon-containing compound (C) is not particularly limited, and examples thereof include silica such as water-dispersible silica and the like, water-soluble silicate compounds such as sodium silicate, potassium silicate, lithium silicate and the like, silicate esters, alkyl silicates such as diethyl silicate and the like, etc. Among them, silica is preferred because it has an effect of enhancing a barrier property of the chemical conversion coat, and water-dispersible silica is more preferred because it has high dispersibility in the chemical conversion treating agent. The water-dispersible silica is not particularly limited, and examples thereof include spherical silica, chain silica, aluminum modified silica and the like, which contain fewer impurities such as sodium. The spherical silica is not particularly limited, and examples thereof include colloidal silica such as “SNOWTEX N”, “SNOWTEX O”, “SNOWTEX OXS”, “SNOWTEX UP”, “SNOWTEX XS”, “SNOWTEX AK”, “SNOWTEX OUP”, “SNOWTEX C”, “SNOWTEX OL” and the like (produced by Nissan Chemical Industries, Ltd.), fumed silica such as “AEROSIL” (produced by Nippon Aerosil Co., Ltd.), and the like. The chain silica is not particularly limited, and examples thereof include silica sol such as “SNOWTEX PS-M”, “SNOWTEX PS-MO”, “SNOWTEX PS-SO” (produced by Nissan Chemical Industries, Ltd.), and the like. Examples of the aluminum-modified silica include commercially available silica sol such as “ADELITE AT-20A” (produced by Asahi Denka Co., Ltd.), and the like.

The content of the silicon-containing compound (C) is preferably within a range from 1 ppm of a lower limit to 5000 ppm of an upper limit in terms of a silicon content. When the above-mentioned content is less than 1 ppm, the corrosion resistance of a chemical conversion coat to be obtained is deteriorated and it is not preferred. When the content exceeds 5000 ppm, any more improvement in an effect is not recognized and it is economically disadvantageous and the adhesion may be deteriorated after coating. The lower limit is more preferably 5 ppm and the upper limit is more preferably 2000 ppm.

As the silicon-containing compound (C), there can also be further given a silane coupling agent and hydrolysates thereof. The silane coupling agent is not particularly limited, but for example, an amino group-having silane coupling agent and the like are suitably used. By mixing the amino group-having silane coupling agent in the chemical conversion treating agent, at an interface between the chemical conversion coat and the film formed by electrodeposition or powder coating, a curing reaction is promoted and the adhesion between the coat and the film is improved. The amino group-having silane coupling agent is not particularly limited as long as it has at least an amino group and a siloxane bond in a molecule.

The amino group-having silane coupling agent is not particularly limited, and examples thereof include N-2 (aminoethyl) 3-aminopropylmethyldimethoxysilane, N-2 (aminoethyl) 3-aminopropyltrimethoxysilane, N-2 (aminoethyl) 3-aminopropyltriethoxysilane, 3-aminopropyltrimethoxysilane, 3-aminopropyltriethoxysilane, 3-triethoxysilyl-N-(1,3-dimethyl-butylidene)propylamine, N-(vinylbenzyl)-2-aminoethyl-3-aminopropyltrimethoxysilane, N,N-bis[3-(trimethoxysilyl)propyl]ethylene diamine, and the like.

The silane coupling agent may be hydrolysates thereof. The hydrolysates of the silane coupling agent can be produced by a publicly known method, for example, a method of dissolving the silane coupling agent in ion-exchanged water and making the silane coupling agent solution acidic with arbitrary acid.

The components (A), (B) and (C) may be used singly or may be used in combination of two or more components as required. When two or more components are simultaneously used, the contents of the respective components preferably fall within the above-mentioned ranges, respectively, and the total amount of these components is not particularly limited.

As a particularly preferable combination, there can be given a combination of at least one metal ion selected from the group consisting of a zinc ion, a magnesium ion, a calcium ion, an aluminum ion and an iron ion (A), and a copper ion (B), and a combination of a silicon-containing compound (C) and a copper ion (B).

The chemical conversion treating agent of the present invention is preferably adjusted in such a way that its pH falls within a range from 1.5 of a lower limit to 6.5 of an upper limit. When the pH is lower than 1.5, there may be cases where the adhesion of a film cannot be not adequately improved since the water-soluble epoxy compound becomes hard to precipitate. When the pH exceeds 6.5, a chemical conversion treatment reaction may not proceed satisfactorily. The lower limit is more preferably 2.0, and the upper limit is more preferably 5.5. The lower limit is furthermore preferably 2.5, and the upper limit is furthermore preferably 5.0. Since the chemical conversion treating agent of the present invention may contain a complex fluoride ion, nitrates, sulfates and fluoride salts as described above, it is preferred to add an alkaline component for adjusting the pH within the above-mentioned range. An alkaline component to adjust the pH is not particularly limited, and examples thereof include sodium hydroxide, potassium hydroxide, ammonia, amine compounds and the like.

Preferably, the chemical conversion treating agent of the present invention does not substantially contain phosphate ions. “Not containing substantially phosphate ions” means that phosphate ions are not contained to such an extent that they act as a component in the chemical conversion treating agent. When the chemical conversion treating agent does not substantially contain phosphate ions, phosphorous resulting in an environmental burden will not be substantially used and the formation of sludge such as iron phosphate, zinc phosphate and the like, which are produced in using a zinc phosphate treating agent, can be inhibited. Further, an environmental burden due to phosphorous vanishes and this is of great advantage to the workability of waste water treatment.

A method of treating a metal surface with the chemical conversion treating agent of the present invention is not particularly limited and it can be performed by bringing the chemical conversion treating agent into contact with the metal surface. A treatment method is not particularly limited, and examples thereof include an immersion method, a spray method, a roller coating method and the like.

In the above-mentioned treatment method, the treatment is preferably performed at a temperature of the chemical conversion treatment solution within a range from 20° C. of a lower limit to 70° C. of an upper limit. By performing a reaction within such a temperature range, a chemical conversion treatment reaction can be performed efficiently. The lower limit is more preferably 30° C. and the upper limit is more preferably 50° C. A treatment time, which varies with the concentration of the chemical conversion treating agent or the treatment temperature, is preferably 20 to 300 seconds.

In the above-mentioned treatment method, it is preferred to perform degreasing and post-degreasing rinsing before the chemical conversion treatment with the chemical conversion treating agent and to perform rinsing after the treatment.

The degreasing treatment is generally carried out by immersing the substrate for about several minutes at 30 to 55° C. in a degreasing agent such as a phosphorus-free and nitrogen-free cleaner in order to remove the oil or the stains adhering to the surface of the substrate. It is also possible to carry out pre-degreasing treatment prior to the degreasing as desired.

The post-degreasing rinsing treatment is performed by spraying once or more with a large amount of rinsing water in order to wash the cleaner with water after the degreasing treatment.

The post-chemical conversion rinsing treatment is performed once or more in order not to adversely affecting the adhesion, the corrosion resistance and the like after subsequent various coatings. In the case of performing the post-chemical conversion rinsing treatment, it is appropriate that final rinsing is performed with pure water. In this post-chemical conversion rinsing treatment, the rinsing may be carried out by either spraying or immersion, or rinsing may be carried out in combination of these techniques.

In addition, the chemical conversion treatment in which the chemical conversion treating agent of the present invention is used is excellent also in terms of workability because it can be performed without carrying out the surface conditioning.

In the chemical conversion treatment in which the chemical conversion treating agent of the present invention is used, a drying process is not necessarily required after the above-mentioned post-chemical conversion rinsing treatment. Even though the chemical conversion coating is coated while being wet without carrying out the drying process, this does not have an adverse influence on performance to be attained. When the drying process is carried out, it is preferred to carry out cold air drying, hot air drying or the like. In case of the hot air drying, it is carried out at a temperature of 300° C. or less in order to prevent the decomposition of an organic substance.

Examples of a metal substrate treated by the chemical conversion treating agent of the present invention include iron-based materials, aluminum-based substrates, zinc-based substrates and the like. An iron-based substrate, an aluminum-based substrate and a zinc-based substrate refer to an iron-based substrate which comprises iron and/or alloys thereof, an aluminum-based substrate which comprises aluminum and/or alloys thereof, and a zinc-based substrate which a comprises zinc and/or alloys thereof, respectively. The chemical conversion treating agent of the present invention can be used for the chemical conversion treatment of an article to be coated comprising a plurality of metal substrates of the iron-based substrate, the aluminum-based substrate and the zinc-based substrate.

The chemical conversion treating agent of the present invention is preferable in that it can form a good coat on even the iron-based substrate in which it is difficult to obtain the adequate adhesion of a film with a common chemical conversion treating agent comprising zirconium, and therefore it has an excellent property in that it can also be used particularly for the treatment of an article to be treated containing at least partially an iron-based substrate. A surface treated metal having a chemical conversion coat formed by the chemical conversion treating agent of the present invention also constitutes the present invention.

The iron-based substrate is not particularly limited, and examples thereof include a cold-rolled steel plate and a hot-rolled steel plate, and the like. The aluminum-based substrate is not particularly limited but may include, for example, No. 5000 series aluminum alloys and No. 6000 series aluminum alloys. The zinc-based substrate is not particularly limited but may include, for example, zinc or zinc alloy-coated steel plate by zinc-based electrodeposition, dip coating or vapor deposition coating, such as zinc-coated (galvanized) steel plate, a zinc-nickel-coated steel plate, a zinc-iron-coated steel plate, a zinc-chromium-coated steel plate, a zinc-aluminum-coated steel plate, a zinc titanium-coated steel plate, a zinc-magnesium-coated steel plate, a zinc-manganese-coated steel plate, and the like.

The iron-based substrate, the aluminum-based substrate and the zinc-based substrate can be simultaneously chemically treated using the above-mentioned chemical conversion treating agent. As an article to be treated, which is treated by the chemical conversion treating agent of the present invention, an automobile body is particularly preferred.

An amount of a chemical conversion coating obtained by the chemical conversion treating agent of the present invention is preferably within a range from 0.1 mg/m² of a lower limit to 500 mg/m² of an upper limit in terms of the total amount of all metals supplied from the chemical conversion treating agent and carbons in the epoxy compound. When the amount is less than 0.1 mg/m², a uniform chemical conversion coat is not obtained and it is not preferred. When the content exceeds 500 mg/m², it is economically unfavorable. The lower limit is more preferably 5 mg/m² and the upper limit is more preferably 200 mg/m².

Coating, which can be applied to a metal substrate having a chemical conversion coat formed by the chemical conversion treating agent of the present invention, is not particularly limited and publicly known coating such as cationic electrodeposition, powder coating and the like can be applied. Since the chemical conversion treating agent of the present invention can give good treatment to all metals such as iron, zinc, aluminum and the like, it can be suitably used particularly as pretreatment of cationic electrodeposition for an article to be treated comprising an iron-based substrate at least partially. The above-mentioned cationic electrodeposition is not particularly limited and publicly known cationic electrodeposition coating compositions comprising an aminated epoxy resin, an aminated acrylic resin and a sulfonium introduced epoxy resin can be applied.

The chemical conversion treating agent of the present invention is a chemical conversion treating agent containing zirconium as a component forming a coat. It can be used for pretreatment of coating metal surface, which improve an adhesion between the metal and a film, because the chemical conversion coat formed by the chemical conversion treating agent of the present invention have good adhesion to a film. Further, the chemical conversion treating agent of the present invention can form a good chemical conversion coat on the iron-based substrate, adequate adhesion to which could not be obtained by a conventional chemical conversion treating agent comprising zirconium and the like, and can treat the surfaces comprising various metal materials such as iron, zinc, aluminum and the like by one operation.

### BEST MODES FOR CARRYING OUT THE INVENTION

Hereinafter, the present invention will be described in more detail by way of examples, but the present invention is not limited to these examples. Further, in the examples, term “part(s)” means “part(s) by weight” unless otherwise specified, and “%” refers to “% by weight” unless otherwise specified.

### EXAMPLES 1 TO 9 AND COMPARATIVE EXAMPLES 1 to 5

A cold rolled steel sheet (SPC, manufactured by Nippon Testpanel Co., Ltd., 70 mm×150 mm×0.8 mm), a hot dip galvanized steel sheet (GA, manufactured by Nippon Testpanel Co., Ltd., 70 mm×150 mm×0.8 mm) and an aluminum steel sheet for automobiles (AP, 6K21 manufactured by Kobe Steel, Ltd., 70 mm×150 mm×0.8 mm) were used as a substrate and pretreatment of coating was applied to these substrates under the following conditions.

(1) Pretreatment of Coating

Degreasing treatment: Each steel sheet was immersed at 40° C. for 2 minutes in 2% by weight “SURFCLEANER EC92” (a cleaner produced by Nippon. Paint Co., Ltd.).

Post-degreasing rinsing treatment: the sheet was treated for 30 seconds by spraying with running water.

Chemical conversion treatment: Chemical conversion treating agents containing the components shown in Table 1 were prepared and the chemical conversion treatment was performed by immersing the metal substrates in the agents for 60 seconds. In adjusting a pH, nitric acid and sodium hydroxide were used. As a source of zirconium, H₂ZrF₆ was used and as supply sources of metals to be added, nitrate salts of the metals were used.

Resins A to C used here are a resin A: a water-borne bisphenol F-type epoxy resin having an amino group and an isocyanate group (produced by Asahi Denka Co., Ltd., number-average molecular weight: 500), a resin B: a bisphenol F-type epoxy resin (produced by Asahi Denka Co., Ltd., number-average molecular weight: 500 or more), and a resin C: a bisphenol F-type epoxy resin having an isocyanate group (produced by Asahi Denka, Co., Ltd., number-average molecular weight: 2000).

Post-chemical conversion rinsing treatment: Each steel sheet was treated for 30 seconds by spraying with running water.

Further, the steel sheet was treated for 30 seconds by spraying with ion-exchanged water.

The rinsed metal substrate was electrodeposited while being wet without drying.

(2) Coating

After each metal substrate was treated with the chemical conversion treating agent of 1 L/m² of the metal substrate area, the metal substrate was electrodeposited in such a way that a dried film thickness was 20 μm with “POWERNIX 110G” (a cationic electrodeposition coating produced by Nippon Paint Co., Ltd.), rinsed with water and then baked by heating at 170° C. for 20 minutes.

Next, ORGA P-30 (a melamine curable intermediate coating composition produced by Nippon Paint Co., Ltd., trade name), which had been previously diluted so as to be 25 seconds in viscosity (measure at 20° C. using a No. 4 Ford cup), was applied at two stages by air spraying in such a way that a dried film thickness was 35 μm, and after applying the intermediate coating composition, setting of five minutes was carried out. Then, the intermediate coating composition was preheated at 80° C. for 3 minutes.

After the preheating, a coated sheet was left standing to be cooled to room temperature, and ORGA G-65 (produced by Nippon Paint Co., Ltd.) was applied as a top coating composition at one stage with Micro Micro Bell (a rotary atomizing type electrostatic coating machine produced by Ransburg: Industrial Finishing K.K.) in such a way that a dried film thickness was 35 μm, and setting of seven minutes was carried out. Further, the top coating composition was baked at 140° C. for 18 minutes to form a multilayer film on the sheet, and a test speciment was obtained.

### COMPARATIVE EXAMPLE 6

A test specimen was obtained in the same procedure as in Example 1 except that after the post-degreasing rinsing treatment, surface conditioning was carried out at room temperature for seconds using SURFFINE 5N-8M (produced by Nippon Paint Co., Ltd.) and the chemical conversion treatment was applied by carrying out immersion treatment at 35° C. for 120 seconds using “SURFDINE SD-6350” (a zinc phosphate chemical conversion treating agent produced by Nippon Paint Co., Ltd.).

Evaluation Test

(Appearance of Bath)

After each metal substrate was treated with the chemical conversion treating agent of 1 L/m² of the metal substrate area, the turbidity in the chemical conversion treating agent was visually observed. The results of evaluations are shown in Table 1.

(Secondary Adhesion Test (SDT))

After cutting the two longitudinally parallel slits reaching a basis material on the surface of each substrate, which is coated by electrodeposition and before intermediate coating and top coating, the coated substrate was immersed in a 5% aqueous solution of NaCl at 50° C. for 480 hours and for 720 hours. Then, the slit portion was peeled off with a tape and peeling of a film was observed and evaluated according the following criteria.

⊚: less than 1 mm

◯: 1 mm to less than 2 mm

Δ: 2 mm to less than 3 mm

X: 3 mm or more

The results of evaluations are shown in Table 1.

(Natural Weathering Test)

After cutting the slits of 10 cm in length in such a way that two slits cross each other at the center in the surface of each of the obtained test specimens with an intermediate coating film and a top coating film, the specimens were subjected to a weathering test at the Miyakojima Weathering Test Center of Nippon Paint Co., Ltd. based on a direct exposure test (according to JIS Z 2381 “General requirements for atmospheric exposure test” and JIS K 5600-7-6). The location of the Weathering Test Center is as follows.

Location: 3742 Karimata, Hirara, Okinawa-Prefecture, Japan

After a lapse of six months from the initiation of the above-mentioned test, width of a blister of the slit portion was observed and evaluated according the following criteria.

⊚: less than 3 mm

◯: 3 mm to less than 4 mm

Δ: 4 mm to less than 5 mm

X: 5 mm or more

The results of evaluations are shown in Table 1.

TABLE 1

| | | Zr | | | | | | |
|---|---|---|---|---|---|---|---|---|
| | | concentration | Resin | Added | Weathering | SDT | | State of |
| | Substrate | (ppm) | (ppm) | metal(ppm) | test | 480 h | 720 h | bath |
| Example 1 | SPC | 100 | A: 300 | — | ⊚ | ⊚ | ⊚ | Clear |
| Example 2 | SPC | 50 | A: 150 | — | ⊚ | ⊚ | ⊚ | Clear |
| Example 3 | GA | 100 | A: 300 | — | ⊚ | ⊚ | ⊚ | Clear |
| Example 4 | AP | 100 | A: 300 | Mg: 500 | ⊚ | ⊚ | ⊚ | Clear |
| Example 5 | SPC | 100 | A: 300 | Zn: 500 | ⊚ | ⊚ | ⊚ | Clear |
| Example 6 | SPC | 100 | A: 300 | Ca: 10 | ⊚ | ⊚ | ⊚ | Clear |
| Example 7 | SPC | 100 | A: 300 | Al: 30 | ⊚ | ⊚ | ⊚ | Clear |
| Example 8 | SPC | 100 | A: 300 | Cu: 5 | ⊚ | ⊚ | ⊚ | Clear |
| Comparative | SPC | 100 | B: 300 | — | X | X | X | Clear |
| Example 1 | | | | | | | | |
| Comparative | SPC | 100 | — | — | Δ | Δ | Δ | Clear |
| Example 2 | | | | | | | | |
| Comparative | SPC | 100 | A: 3000 | — | ◯ | ⊚ | ◯ | Whitish |
| Example 3 | | | | | | | | turbidity |
| Comparative | SPC | 100 | A: 50 | — | X | ◯ | Δ | Clear |
| Example 4 | | | | | | | | |
| Comparative | SPC | 100 | C: 300 | — | ◯ | ⊚ | ◯ | Whitish |
| Example 5 | | | | | | | | turbidity |

| | | | | | | |
|---|---|---|---|---|---|---|
| Comparative | SPC | Zinc phosphate treatment | ⊚ | ⊚ | ⊚ | Clear |
| Example 6 | | | | | | |

From Table 1, it was shown that the formation of sludge was not found in the chemical conversion treating agents of the present invention and the chemical conversion coats obtained by using the chemical conversion treating agent of the present invention had good adhesion of a film. On the other hand, the chemical conversion coats obtained by using ones prepared in the comparative examples could not attain good results in all evaluation items.

### INDUSTRIAL APPLICABILITY

The chemical conversion treating agent of the present invention is a good chemical conversion treating agent because it does not need to use heavy metals such as chromium and the like, which have large environmental impact. And it is also a chemical conversion treating agent in terms of workability and cost because a good chemical conversion coat is formed without carrying out the surface conditioning in the chemical conversion treatment in which the chemical conversion treating agent of the present invention is used. Further, since the chemical conversion treating agent of the present invention can provide the adequate adhesion of a film for an iron-based substrate, it is possible to apply treatment even to an article to be treated comprising at least partially an iron-based substrate in accordance with the present invention.

1. A chemical conversion treating agent comprising zirconium, fluorine and a water-soluble epoxy compound,
wherein the content of the zirconium in the chemical conversion treating agent is 20 to 10000 ppm on the metal equivalent basis,
the water-soluble epoxy compound has a fundamental skeleton of bisphenol F, has an amino group and an isocyanate group, has a number-average molecular weight of 400 to 1000, and the content of the water-soluble epoxy compound in the chemical conversion treating agent is 100 to 2000 ppm in terms of the concentration of solid matters.

2. The chemical conversion treating agent according to claim 1, further comprising:
at least one member selected from the group consisting of at least one metal ion selected from the group consisting of a zinc ion, a magnesium ion, a calcium ion, an aluminum ion and an iron ion (A); a copper ion (B); and silicon-containing compound (C).

3. The chemical conversion treating agent according to claim 1,
wherein the silicon-containing compound (C) is at least one member selected from the group consisting of silica, a water-soluble silicate compound, silicate esters, alkyl silicates and a silane coupling agent.

4. The chemical conversion treating agent according to claim 1,
which has a pH of 1.5 to 6.5.

5. A surface treated metal having a chemical conversion coat obtainable from the chemical conversion treating agent according to claim 1.

6. The surface treated metal according to claim 5, wherein an amount of the chemical conversion coat is 0.1 to 500 mg/m in terms of the total amount of all metals supplied from the chemical conversion treating agent and carbons in the epoxy compound.

7. The surface treated metal according to claim 5, wherein an article to be treated is an automobile body.

8. The chemical conversion treating agent according to claim 2,
wherein the silicon-containing compound (C) is at least one member selected from the group consisting of silica, a water-soluble silicate compound, silicate esters, alkyl silicates and a silane coupling agent.

9. The chemical conversion treating agent according to claim 2,
which has a pH of 1.5 to 6.5.

10. The chemical conversion treating agent according to claim 3,
which has a pH of 1.5 to 6.5.

11. A surface treated metal having a chemical conversion coat obtainable from the chemical conversion treating agent according to claim 2.

12. A surface treated metal having a chemical conversion coat obtainable from the chemical conversion treating agent according to claim 3.

13. A surface treated metal having a chemical conversion coat obtainable from the chemical conversion treating agent according to claim 4.

14. The surface treated metal according to claim 6, wherein an article to be treated is an automobile body.
